(19) United States
(12) Patent Application Publication
(10) Pub. No.: US 2025/0051044 A1
(43) Pub. Date: Feb. 13, 2025

(54) Integrated Aerial Delivery and Vertical Transport System with Non-Landing Drone Interaction

(71) Applicant: Sushanta Khadka, North Salt Lake, UT (US)

(72) Inventor: Sushanta Khadka, North Salt Lake, UT (US)

(21) Appl. No.: 18/231,323

(22) Filed: Aug. 8, 2023

(51) Int. Cl. B64U 10/25; G05D 1/10

(52) U.S. Cl. CPC B64U 10/25; B64U 2101/64; B64U 2201/00

(57) ABSTRACT

A novel form of integrated aerial delivery and vertical transport system with non-landing drone interaction to provide a secure, weather-protected, and efficient method of package delivery. Its versatility and advantages make it valuable for various industries, enhancing convenience, reliability, and customer satisfaction.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark OJfice patent files or records, but otherwise reserves all copvright rights whatsoever.

### BACKGROUND

### Field of the Invention

The present invention relates to drone technology and is more particularly related to an integrated aerial delivery and vertical transport system with non-landing drone interaction that revolutionizes drone delivery with non-landing drone interaction.

### Description of the Related Art

Drones, also called unmanned aerial vehicles (UAVs), have no human pilot onboard, and instead are either controlled by a person on the ground or autonomously via a computer program. These stealth craft are becoming increasingly popular, not just for war and military purposes, but also for everything from wildlife and atmospheric research to disaster relief and sports photography. Drones are becoming the eyes and ears of scientists by surveying the ground for archaeological sites, signs of illegal hunting and crop damage, and even zipping inside hurricanes to study the wild storms.

There are multiple inventions that have been seen in prior art regarding drone technology. For instance, Device for piloting a drone bearing European patent EP2,3568,06B1 is issued to Parrot SA. The patent discloses an invention relates to a device (10) for piloting a drone (8), including a housing provided with a housing inclination detector (12) and a touchscreen (16), displaying a plurality of touch-sensitive areas (30, 32, 34, 36, 38, 40, 42). The drone is provided with a self-contained stabilization system for stationary flight when no other command is received from a user. The device includes a means, controlled by a tactile area (30) forming an activation/deactivation button, for alternately switching the drone piloting mode between (i) a mode of activating the self-contained stabilization system of the drone, in which the piloting commands sent to the drone are the result of transforming signals emitted by the touch-sensitive areas, and (ii) a mode of deactivating the self-contained stabilization system of the drone, in which the piloting commands sent to the drone are the result of transforming signals emitted by the inclination detector of the housing.

A Drone cleaning device bearing U.S. patent 2,017,0340,176A1 is issued to Hon Hai Precision Industry Co Ltd. The patent discloses a drone cleaning device for a building exterior comprises a main frame, a plurality of branch shafts set to the main frame, a plurality of power elements respectively set to the branch shafts, a plurality of adjustable supports set to the main frame, a plurality of rotatable elements respectively set to the adjustable supports and are configured to rotate relative to the adjustable supports, and a plurality of cleaning elements respectively set to the rotatable elements.

A Drone control method and device, ground control system and drone bearing Canadian patent 1,049,325,25A is issued to Chinese inventor. The patent discloses a drone control method comprising the steps that the current position and attitude of a drone are acquired; whether the drone enters a restricted area or a no-fly area is judged according to the current position and attitude of the drone; and when the drone enters the restricted area or the no-fly area, flight of the drone is controlled according to a flight control strategy corresponding to the area. The invention also discloses drone control device, the drone with the control device and a ground control system. The drone is enabled to automatically avoid the no-fly area so that flight efficiency and flight safety can be enhanced.

A Noise suppression device for a drone launch tube bearing European patent EP3,133,019B1 is issued to Aerovironment Inc. The patent discloses a 1. An unmanned aerial vehicle (UAV) launch tube (1010; 1310; 1520) which is closed at one end and comprises: a tethered sabot (700; 1050) configured to engage a UAV (1020; 1200) within a launcher volume defined by an inner wall, the tethered sabot dimensioned to provide a pressure seal at the inner wall and tethered to the inner wall.

Another patent Counter drone device, and method of using the same bearing U.S. Pat. No. 2,019,008,6184A1 is issued to Stan William Sands. The patent discloses a counter drone device adapted to render propellers of drones inoperable. The counter drone device may be a weighted filament adapted to be projecting into the propeller of a drone so as to entangle/ensnare/wrap around propeller shaft and/or blades, rendering the drone inoperable.

A Device for launching and recovering a drone, and an associated aircraft bearing U.S. Pat. No. 2,012,029,2430A1 is issued to Airbus Helicopters SAS. The patent discloses a device (10) for launching and recovering a drone (5), the device being suitable for being fastened to an aircraft. The device includes docking means (20) for a drone (5), the docking means (20) being provided with securing/releasing means (30) for the drone (5), said docking means (20) being secured to flared guide means (40) for guiding the drone (5) towards said docking means (20).

A Taking-off and landing system for drone, and operating method therefor bearing WIPO patent WO2,0160,890,66A1 is issued to a Korean inventor. The patent relates to a taking-off and landing system for a drone and, more specifically, to: a system in which a product is transported by a drone, in an unmanned way, to a device, possessed by a user, for enabling the drone to take-off and land; and an operating method therefor. The present invention comprises: a base (11) for providing a floor on which a drone (30) takes off and lands; a storage unit (13) for storing an ID of the base; and a first short range communication module (15) for wirelessly communicating with the drone accessing the base within a predetermined distance, wherein the first short range communication module transmits, to the drone, the ID of the base when the drone comes within a predetermined distance, and transmits a landing guide signal when a landing intention signal is received from the drone.

A Photographing device and method using drone to automatically track and photograph moving object earing WIPO patent WO2,017,0208,56A1 is issued to French & Chinese inventor. The patent discloses a device using a drone to automatically track and photograph a moving object, comprising: a drone flight platform, a load stabilization device, a photographing apparatus, and a mobile terminal, wherein the photographing apparatus is fixed to the drone flight platform via the load stabilization device and is configured to take an image of a moving object, and the mobile terminal is disposed on the moving object and can acquire location information of the moving object. According to location information of the drone flight platform and the moving object, a flightpath of the drone flight platform and a relative location of the photographing apparatus with respect to the drone flight platform are adjusted. Moreover, an orientation of the photographing apparatus is adjusted according to the image taken by the photographing apparatus, thereby enabling the photographing apparatus to track the moving object. The invention further relates to a method using a drone to automatically track and photograph a moving object, drone and control terminal.

A Drone equipped with spraying device bearing Japanese patent JP3,217,561U is issued to Japanese inventor. The patent discloses a drone is flying between the apples and various fruit trees and fruit trees vertically and horizontally, and sprayed pest control and pollinizer pollen provides drone mounted spray device for use in hand-pollination. A machine body 2, a plurality of rotor arms 3 extending in the horizontal radially from machine body center, a plurality of the electric motor 4 that is fixed to the distal end of the rotor arm, a plurality of propeller to be connected to the electric motor 5 comprising the in drone comprising a plurality of legs 6 that extend downwardly from the bottom surface of the machine body, injectable injection nozzle 11a of liquid spray material which is pumped by the pump in any direction, the spraying device comprising a 11b. Spraying device comprises a hose guide 14 which extends disposed in machine body and the horizontal lateral direction, attaching the hose guide is connected to the tip ejection nozzle connecting portion of the hose, the electric motor, the injection nozzle houses the rotary encoder comprising a spray unit 15a.

There are multiple solutions that have been presented in the prior art. However, these solutions are limited and restricted to their conventional systems. The current invention is focused on presenting methods and systems for air transportation of goods and/or people using autonomous and/or remotely piloted unmanned aircraft vehicles (UAV). In particular, the systems include the following components: autonomous electric flying vehicles, automated ground stations, and logistics software that operates the system.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of methods and systems for air transportation of goods and/or people using autonomous and/or remotely piloted unmanned aircraft vehicles (UAV).

It is also the primary objective of the invention to provide an assembly that can fit any drone and if a drone malfunctions, the device will automatically deploy a parachute to let the drone land safely without any damage.

It is another objective of the invention is to provide a delivery system comprises of one or more unmanned delivery vehicles configured for autonomous navigation, a plurality of ground stations configured to communicate with one or more unmanned delivery vehicles, and provide location information to one or more unmanned delivery vehicles to aid in locating a ground station location and a processor configured to identify a route from a first of the plurality of ground stations to a second of the plurality of ground stations based on geographic data and providing the route to the one or more unmanned delivery vehicles for use in the autonomous navigation from the first to the second ground station.

It is also the object of the invention to provide a non-landing drone interaction wherein a safe delivery process with minimal disturbance is provided.

It is also the object of the invention to provide an assembly that facilitates the efficient movement of packages from drop-off pod to collection areas

It is a further objective of the invention to provide a system that provides designated house collection areas or centralized units for secure storage.

It is also the objective of the invention to provide a smart, secure, weather-Protected, and efficient delivery system that mitigates risks of theft, weather damage, and physical handling.

Thus, it is the objective to provide a new and improved temperature control for perishable items that maintains appropriate temperature and humidity levels for food, fresh produce, and medications.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an integrated aerial delivery and vertical transport system with non-landing drone interaction that offers a secure, weather-protected, and efficient method of package delivery. The delivery system comprises one or more unmanned delivery vehicles configured for autonomous navigation, a plurality of ground stations configured to communicate with one or more unmanned delivery vehicles and provide location information to one or more unmanned delivery vehicles to aid in locating a ground station location and a processor configured to identify a route from a first of the plurality of ground stations to a second of the plurality of ground stations based on geographic data and providing the route to the one or more unmanned delivery vehicles for use in the autonomous navigation from the first to the second ground station and pneumatic tubes for landing. In an embodiment, one or more unmanned delivery vehicles are aerial vehicles.

In embodiments, the aerial vehicles comprise a package interface capable of accepting a package for transport on the delivery system. In certain embodiments, aerial vehicles comprise safety measures for protecting the package. In embodiments, the safety measures include one or more of a parachute or an airbag.

In certain embodiments, the processor is configured to recognize demand patterns and position one or more unmanned delivery vehicles in a location to meet the demand pattern. In an embodiment, the logistics system authorizes the route for one or more unmanned delivery vehicles. The assembly includes a hovering drop-off pod that provides a safe and designated area for non-landing drone interactions. Vertical Mini Lift in form of an automated system inspired by pneumatic tubes is presented.

In certain embodiments, a computer system manages a delivery system of unmanned aerial vehicles comprising one or more hardware processors in communication with a computer readable medium storing software modules including instructions that are executable by the one or more hardware processors, the software modules including at least: a vehicle routing module that determines a route between a first ground station and a second ground station for an unmanned aerial vehicle; a vehicle tracking module that provides the current location of an unmanned aerial vehicle; a package routing module that determines a delivery path for a package, the delivery path including the first and second plurality of ground stations; a package tracking module providing the current location of the package on the delivery path; and a route authorization module that conditionally authorizes the unmanned aerial vehicle to fly the route between the first and second ground stations to move the package along the delivery path for the package.

In an embodiment, the software modules further comprise a weather monitoring module configured to determine appropriate flying conditions between the first and second ground station and communicate with the route authorization module to authorize the flight when the conditions are appropriate. In an embodiment, the vehicle routing module includes stored information from a successful flight of the unmanned aerial vehicle while under the control of a pilot. In an embodiment, the route authorization module is configured to refuse to authorize a flight based on a user command.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A delivery system comprising:
one or more unmanned delivery vehicles configured for autonomous navigation;
a plurality of ground stations configured to communicate with one or more unmanned delivery vehicles and provide location information to the one or more unmanned delivery vehicles to aid in locating a ground station location; and
a processor configured to identify a route from the first of the plurality of ground stations to a second of the plurality of ground stations based on geographic data and providing the route to one or more unmanned delivery vehicles for use in autonomous navigation from the first to the second ground station.

2. The delivery system of claim 1, wherein one or more unmanned delivery vehicles are aerial vehicles.

3. The delivery system of claim 1, wherein the aerial vehicles comprise a fixed wing and a rotor.

4. The delivery system of claim 1, wherein the aerial vehicles comprise a payload interface capable of accepting a package for transport on the delivery system.

5. The delivery system of claim 1, wherein a hovering drop-off pod is presented.

6. The delivery system of claim 1, wherein the drop-off pod provides a safe and designated area for non-landing drone interactions.

7. The delivery system of claim 1, wherein the drop-off pod provides precise and secure drop-offs without physical drone landings.

8. The delivery system of claim 1, wherein the vertical Mini Lifts are utilized for delivery is an automated system inspired by pneumatic tubes.

9. The delivery system of claim 1, wherein packages are transported from drop-off pod to collection areas and then dispersed to designated house collection areas or centralized units in buildings.
